(19) United States
(12) Patent Application Publication
(10) Pub. No.: US 2015/0048927 A1
(43) Pub. Date: Feb. 19, 2015

(54) SMARTPHONE BASED PASSIVE KEYLESS ENTRY SYSTEM

(71) Applicant: Directed, LLC, Vista, CA (US)

(72) Inventor: Michael S. Simmons, Aliso Viejo, CA (US)

(73) Assignee: DIRECTED, LLC, Vista, CA (US)

(21) Appl. No.: 14/459,036

(22) Filed: Aug. 13, 2014

Related U.S. Application Data
(60) Provisional application No. 61/865,514, filed on Aug. 13, 2013.

(51) Int. Cl. G07C 9/00

(52) U.S. Cl. CPC G07C 9/00007; G07C 2009/00769
USPC 340/5.61

(57) ABSTRACT

A passive keyless entry system is provided comprising an access point module, a smart phone for capable of transmitting an identification and proximity signal, the passive keyless entry system allows the user to program or set the distance for activating the passive triggering of the lock mechanism using radio signal strength indication means of a smart phone. The invention further provides for setting of a parameter boundary whereby the passive keyless entry system is disabled either manually or though an automated process or whereby a user can set a perimeter around a specified point location whereby a passive keyless entry system is disabled when a smart phone is within the perimeter and enabled the passive keyless entry system when outside of the perimeter.

### REFERENCE TO RELATED PATENTS

This application claims the benefit of U.S. Provisional Patent Application Ser. No. 61/865,514 filed Aug. 13, 2013 entitled SMARTPHONE BASED PASSIVE KEYLESS ENTRY SYSTEM

### FIELD OF THE INVENTION

The field of the invention is passive keyless entry systems.

### BACKGROUND

Passive keyless entry systems are known that utilize a key fob, a user held remote control unit, or other radio frequency transmitter device in the possession of the user to communicate a lock or unlock command to an automobile, building or other product with an access entry point. Actuation of the command is typically accomplished by pushing a button on the transmitter. While using a remote is often more convenient than using a key, the user still requires a free hand to operate the remote. Thus, the user held remote, like a key, still requires an extra step by the user to lock or unlock the door.

One solution eliminates the extra step by using a proximity detection means to trigger locking and unlocking when entering within a predetermined distance from the passive keyless entry system. Such systems typically use a radio signal-emitting portable device, and are known to operate on many different frequencies and protocols, including for example UHF, and radar. Generally, a hand held unit continuously transmits a wireless signal that when received by a receiver at the access point causes the lock mechanism to trigger unlocking the access point. One problem with such a system is that the signal detection range can vary greatly from system to system, especially in aftermarket applications where environmental and installation factors can vary greatly. This causes locking and unlocking at a distance that is inconsistent and may not be desired in certain context. Another problem is that constant transmission by the handheld unit quickly drains the battery life, requiring constant recharging or battery replacement. If the user fails to recharge, access to the vehicle will not be allowed because a signal is no longer transmitted. Additionally, these systems tend to trigger a locking mechanism to lock and unlock each time a user crosses the threshold of the distance set for the detection system. Thus, in a poorly configured system, a door might well unlock when the user is within the detection range, whether or not the user intended it.

Another solution provides for a system that includes an encoded transponder or other type of RF ID tag embedded in a handheld unit and a power emitting module with a transceiver mounted near the entry point and in communication with the locking mechanism. The module transmits energy to the transponder, and when the transmitter absorbs the energy it transmits an identification or access authorization code back to the module receiver. If the code is an authorized code the lock mechanism triggers. This solution provides some improvement because the system relies on the vehicle battery for power, allowing for recharging when the vehicle is driven. However, the module must constantly transmit a signal to query the transponder to allow the transponder to reply with an identification signal back to the module. This again requires the system to use more power than is desirable. If the vehicle is not regularly driven, this type of system may drain the vehicle battery, not only preventing access to the vehicle, but also preventing start of the engine. Additionally, transponder based systems are limited in that they typically operate at 125 KHZ, with resulting low range. While these low frequency systems result in good control of range, it does not integrate well with aftermarket systems, which typically operate at 434 MHZ. Such a system creates significant installation limitations for aftermarket applications.

Passive keyless entry systems have the advantage of eliminating the step of actively engaging the user to depress switches on the handheld remote altogether. For example, U.S. Patent App. no. 2006/0232378 to Ogino (pub. October 2006), which is fully incorporated herein, teaches a piezoelectric sensor that cooperates with a keyless entry system to prevent unintended opening of the vehicle. Ogino resolves some of the problems listed above, but requires extensive wiring, and therefore must typically be factory-installed. For a structure, The Ogino system must be planned into the overall design and integrated into the vehicle or building at the time of construction. Among other things, such systems often require wiring to a powered, high frequency antenna as well as to a wired touch sensor at each entry point. These assemblies require power and ground connections, as well as physical wiring to a main module to process the detected signals. Thus, the cost for the extensive wiring generally prohibits aftermarket installation.

Another limitation in particular aftermarket systems, where it is impractical to embed an actuator in the car door handle as is typical of OEM factory installed passive keyless entry systems, is that the distance between the transmitter and receiver at which the passive keyless entry system engages lock mechanism cannot be conveniently changed or adjusted for user or situational preferences. Additionally, current passive keyless entry systems do not provide for disabling of the system when it is anticipated that the trigger device may move in and out of range causing the system to lock and unlock each time. Current systems are also limited in that they do not conveniently provide for allowing users to disable the passive keyless entry system in locations or situations where disabling is preferred.

The ability to a smart phone to passively control a locking system has been found to be highly desirable. Smart phones have become ubiquitous and consolidate into a single device many function previously performed by multiple devices carried by a user. Thus, there is still a need for a passive keyless entry system whereby a smart phone is used as the proximity location device. There is a need for a system whereby the user can adjust the distance where the system locks and unlock the door. There is yet a further need for a passive keyless entry system that can be selectively enable and disabled. The system also greatly reduces the complexity and expense for aftermarket applications. Where a definition or use of a term in an incorporated reference is inconsistent or contrary to the definition of that term provided herein, the definition of that term provided herein applies and the definition of that term in the reference does not apply.

### SUMMARY OF THE INVENTION

In order to overcome the limitations of the prior art, provided is a passive keyless system and a method for setting the distance and conditions for triggering the lock mechanism of an access area. In the current invention, disclosed is a method of using standard Bluetooth RSSI or other RF power indication protocols to program or set the distance for the lock and unlock of an access point in a passive keyless entry system. It is an objected of the present invention to provide a passive keyless entry system that allows the user to program or set, using a simple user interface, the distance that passive triggering of the lock mechanism occurs using the radio signal strength indication processes of a smart phone. It is an object of the current invention to provide a passive keyless entry system whereby the user can program or set disabling parameters or conditions of the passive keyless entry system either manually or though an automated process. It is yet a further object of the invention to provide a method for setting on a smartphone app a perimeter around a specified point location whereby a passive keyless entry system is disabled when a smart phone is within the perimeter and enabling the passive keyless entry system when outside of the perimeter.

### BRIEF DESCRIPTION OF THE DRAWING

FIG. 1 is a schematic representation of the in-vehicle module of the current system.

FIG. 2 is a graphical representation of the smart phone graphic user interface screen of the passive keyless entry system.

FIG. 3 is a flowchart for a method for facilitating programming the distance whereby the passive keyless entry system locking and unlocking mechanism triggers.

FIG. 4 is a flowchart for a method for the locking and unlocking of an access point of the passive keyless entry system of the current invention.

### DETAILED DESCRIPTION

The present invention provides for a passive keyless entry system and method that provides for setting the distance and conditions for triggering a lock mechanism using a short range RF enabled smart phone paired with an enabled transceiver module installed in a vehicle, building or other secured access point. Example embodiments are described herein. Those of ordinary skill in the art will realize that the following descriptions are illustrative only and are not intended to be in any way limiting. Other embodiments will readily suggest themselves to such skilled persons having the benefit of this disclosure. Reference will now be made in detail to implementations of the example embodiments as illustrated in the accompanying drawings. The same reference indicators may be used throughout the drawings and will refer to the same or like items.

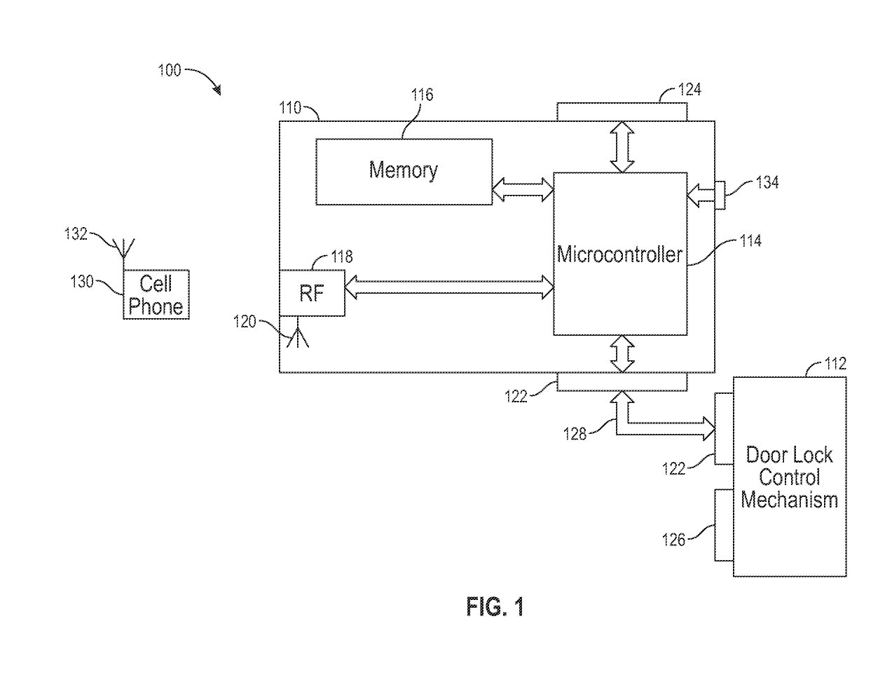

Now with reference to the various figures, FIG. 1, is an exemplary embodiment of the inventive subject matter providing a passive keyless entry system (PKE) 100 comprised of a module 110 associated with a locking mechanism 112. The module 110 is further comprises of a microcontroller 114, memory 116 and radio frequency transceiver 118 with an antenna 120, which may be combined in a single integrated circuit board. The module 110 is in direct electrical communication with the locking mechanism 112, which may be any know electrical or electronic locking mechanism. The locking mechanism 112 may provide an electrical control signal through a second connector 126 to an electric relay that controls the lock. The communication link 128 between the module 110 and lock control mechanism 112 may be through any known electrical communications between devices, but is shown in FIG. 1 as a direct wired connection with Molex® type connectors 122.

The module 110 may be installed in a vehicle, a permanent structure, or any other access point having a locking mechanism. In a vehicle (not shown), the module 110 may be associated with or in communication with a vehicle security system or vehicle data bus system through a wired connection 124, where the module 110 can gather data directly from the vehicle and communicate signals directly to the vehicle. In a building (not shown), the module may be associated with a wireless network, security system of other control devices of the structure.

With continued reference to FIG. 1, the PKE system 100 is further comprised of a user held device 130. The user held device 130 may be any smart phone, with a local radio transceiver 132 (such as Bluetooth®), a cellular network transceiver, a memory, a controller and a downloadable software application that provides machine readable control logic for allowing user access to program and access function settings, command controls, as well as data reporting features of the system. All manner of radio frequency communications are contemplated as the signaling means for identifying the properly associated user held transceiver and communication of command signals.

All antennas suitable for receiving a signal between the module 110 and hand held device 130 are contemplated. While multiple antennas can be used, a single antenna provides for quicker and less costly installation. Preferably, the installer will use an existing antenna of a security system or other wireless communication device that has been previously installed in the vehicle or structure, thereby eliminating the cost of installing additional antenna.

The module 110 and the smart phone 130 are wirelessly paired to allow or authorize local radio communication between the module 110 and smart phone 130. Pairing can be accomplished by any known pairing means. Preferably, the Bluetooth standard is used. Each smart phone 130 transceiver is uniquely encoded with an identifier, which is generally a unique alpha numeric sequence. To pair, the module 130 is put in a programming or paring mode by depressing a switch 134 on the module 130. The identifier code of the smart phone 130 is transmitted and then stored in memory 116 of the module 130. It is contemplated that the pairing can occur by putting the smart phone into a pairing mode and transmitting from the module transceiver 118 to the smart phone 130. Later, when in operating mode, the module 110 receives the identification signal transmitted by the smart phone 130, which is then stored in the module memory 116. It should be noted that a single smart phone 130 may be paired with a plurality of modules 130 to allow a single device to access a large number of access points. After pairing, when a transmission is received, the module 110 compares the received identification from the smart phone 130 against those identifications stored in memory 116 and if matched, communications are authorizes. A plurality of smart phones 130 may be paired with the module 130 with each identifier store into the module memory 116. This allows for a large number of potential authorized users. The identification and time of access for each entry of the access point may be logged into memory for retrieval or transfer to another computer network for reporting.

With the pervasive use of smart phones, the integration of a smart phone based application with a graphical user interface for remotely programming and controlling the locking function of a vehicle, building or access point is highly desirable.

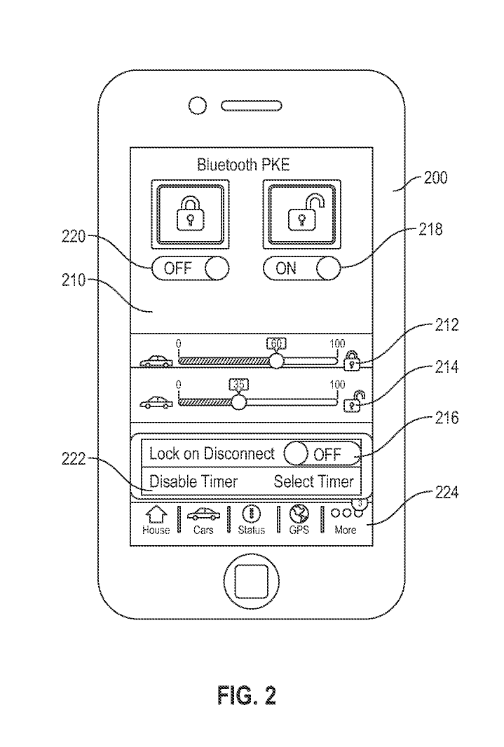

Referring now to FIG. 2, the disclosed invention allows for the use of a smart phone 200 having a software application with a graphical user interface 210 for displayed on the smart phone 200. The application provides for setting the distance around the access point from where the passive keyless entry system will lock and unlock. The user interface 210 provides for sliding bars 212, 214 or other graphical indicator where the location on the scale corresponds as a relative indication of the distance from the access point at which the user wished the PKE to lock or unlock. The user may also select from other selectable features of the system. For example, as is discussed in more detail below, when the user is in the proximity of the access point and cross the distance threshold on multiple occurrences, it may be undesirable or inconvenient for the access point to continuously lock and unlock. So, the user may select the off feature 216 to disable the system when in the activation zone. The feature may also be program to operate during selected time or the disabled at selected times using the timer icon 222. The user may selectively turn on and off independently the lock action 220 or the unlock action 218 with select icons. Special function icons are also displayed 224.

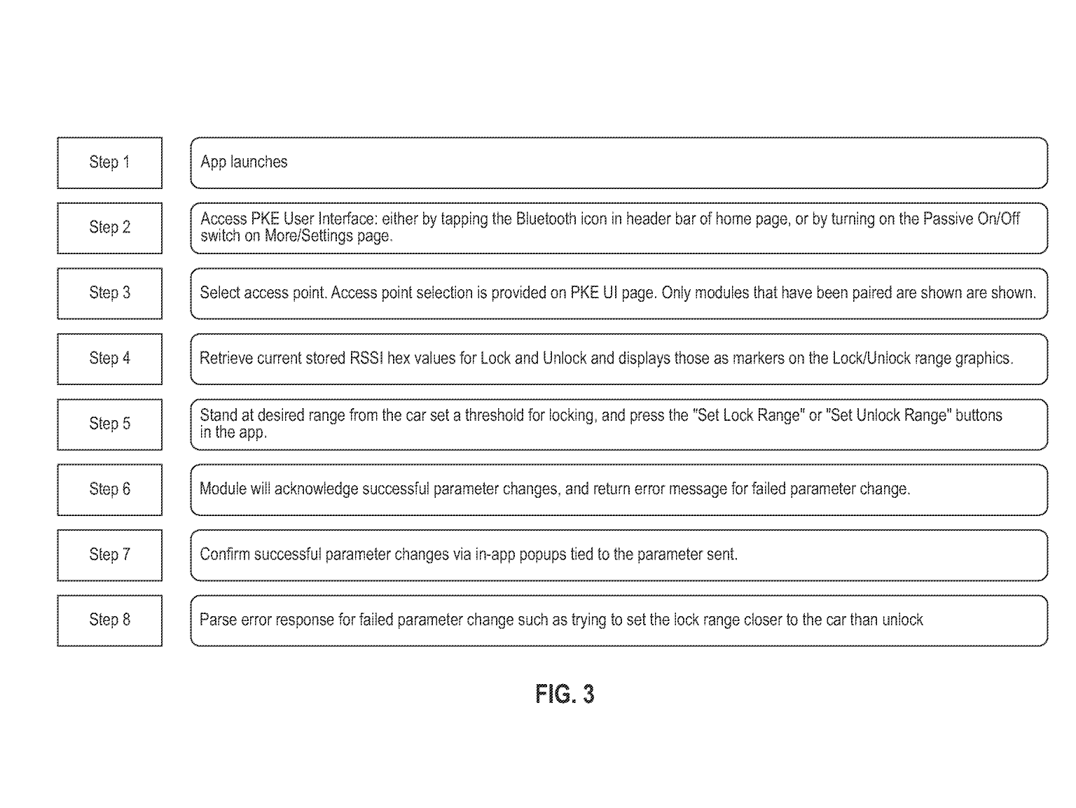

Referring now to FIG. 2 and FIG. 3, in FIG. 3 described is one embodiment of the lock/unlock distance programming routine. At step one, the user interface 210 is accessed on the smart phone 200 launching the PKE application. To avoid inadvertent change of distance parameters, the lock/unlock distance programming routine is available only 60 seconds after power-up and launch of the application.

At step 2, the distance set function is access in the app. This is done either by tapping the Bluetooth icon in the header bar of home page of the user interface 210, or by turning on the Passive On/Off switch on More/Settings page.

At step 3, the user select the desired access point. The smart phone 200 may be paired with a plurality of modules 110 controlling a number of access points. It may be desirable to set different distances for individual access points.

At step 4, and as is discussed in further detail below, the application retrieves the currently stored RSSI hex values for Lock and Unlock and displays those as markers on the Lock/Unlock range graphics 212 and 214.

Step 5, upon selection by the user, the module 110 sets the threshold value for lock/unlock based on the current RSSI value at the module when the command is received. The same logic applies as when setting from graphic; can't set unlock range further away than lock range, can't be too close in RSSI hex value to each other, etc. No values lower than E0 in hex are supported for either command.

At step 6, the module 110 transmits an acknowledgement signal indicating the successful parameter changes, or alternatively provides a return error message for failed parameter change

At step 7, a confirmation of successful parameter changes is displayed in the application via in-app popup tied to the parameter sent.

At step 8, the application will parse the error response for failed parameter change, such as trying to set the lock range closer to the car than unlock, and display the failure message through the graphical user interface.

The disclosed invention uses established received signal strength indicator (RSSI) protocol as a means to set lock trigger distance. RSSI is a generic radio receiver technology metric of the radiant power present in a received radio signal, which is usually observable by a device containing an active receiver. RSSI is a concept deployed in IEEE 802.11 standard protocol family. The IEEE 802.11 protocol family is fully incorporated herein by reference. RSSI is often executed in the intermediate frequency (IF) stage before the IF amplifier. In zero-IF system, it is done in the baseband signal chain, before the baseband amplifier. RSSI output is often a DC analog level. It can also be sampled by an internal ADC and the resulting codes available directly or via peripheral or internal processor bus. In an IEEE 802.11 system, RSSI is the relative received signal strength in a wireless environment, expressed in arbitrary units. RSSI is an indication of the signal power level being received by the antenna. Therefore, the higher the RSSI number, the relatively stronger the signal.

In the current invention, disclosed is a method of using standard Bluetooth RSSI or other RF power indication protocols to program or set the distance for the lock and unlock of an access point in a passive keyless entry system. Generally, RSSI provides a very poor indication of range or location given the unpredictable influences of environment factors, such as line of sight, temperature, humidity, etc. Another factor impacting RSSI strength determination is the orientation of the transceiver antennas at the access point and the orientation of the smart phone antenna. If not properly aligned, signal strength reading is inaccurate or fluctuates over time.

In the current invention, to program the trigger distance, while in a programming mode, the proximity power transmission of the smart phone BLE transmitter initiation signal is set to such a low level that a wireless link cannot be established. On the system provided graphical user interface shown are the current settings for lock 212 and unlock 214 “range”, not necessarily in feet or other distance metric but based on actual RSSI value range in hex. The access point is at one end of the “range” and person could be depicted at the other end of the “range”. The user moves the smart phone to the distance from the access point desired for triggering the lock/unlock mechanism (within 2 meters or so of the car). The proximity power transmission is then increased by the user through the smart phone app to provide customization for each particular vehicle and use pattern.

To execute the protocol for programming the desired trigger distance, as power is increased, the power level of the wireless link is establishment between the module 110 and the smart phone 130, a sample of the RSSI level at the maximum transmission speed (20 ms per sample (t), 50 samples per second) is taken. A number of samples are taken and stored in a buffer. Preferably at least 8 samples are buffered (absolute value, as unsigned 8 bits). When 8 samples are captured (every 160 ms (u)), the following calculation is executed to determine the average signal strength:

Average the 8 Samples

$${A}_{u} = {( ( {( {\sum }_{t = 0}^{7} {( - {RSSI}_{t} )}_{UINTS} )}_{UINT 16} ) ≫ 3 )}_{UINTS}$$

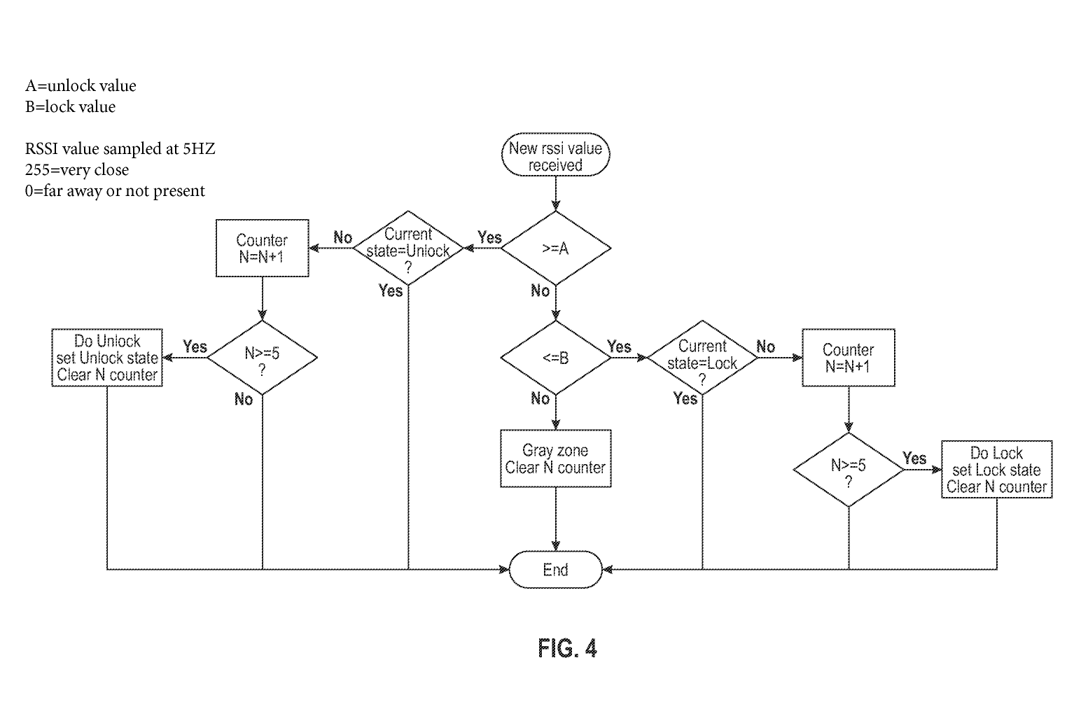

When the module later receives, while in an operating mode, a signal strength that matches or exceed the threshold set by the average, the module sends an unlock signal to the lock mechanism. FIG. 4 shows the flow chart for a method for the locking and unlocking of an access point of the passive keyless entry system of the current invention.

In order to avoid lock and unlock chattering at the trigger distance as the cell phone enters and exits at the border of the proximity zone, a state machine is executed, which consists of the following states:

FAR_AWAY

CLOSE

STABILIZING

VERY_CLOSE

The state machine takes as parameters the averaged RSSI as computed, as well the state of the BTLE connection, and the presence or absence of a timeout event which is described below. The state machine function is called whenever a fresh RSSI average is available, or the communication link state changes.

FAR_AWAY State

In the FAR_AWAY state, the logic determines the connection state between the smart phone and the module. If a wireless communication link connection is detected, logic is executed to transition to the CLOSE state. If no connection is detected the logic requires remaining in the FAR_AWAY state.

In the transition from the FAR_AWAY to the CLOSE states, the module power transmission level is increased to the maximum permitted by the system, for example (+4 dBm on CC2540 device and 0 dBm on cc2541 devices) so that the connection is not suddenly dropped.

Then, the GAP_CONNECTION_TIMEOUT routine is changed to a short value (25 ms) from the default value (400 ms). This is done to ensure that the connection is dropped rapidly if the user moves out of range. If the connection timeout change is successful, initialized is a pair of first order IIR low pass filters, one to filter the RSSI values coming into the state machine, and the second filter the first derivative of the RSSI.

Next a timer is started, which will run to completion and generate a timeout event signal unless the RSSI stabilizes at a very strong level within ten seconds.

The logic then transition to the CLOSE state. If a change to the connection timeout is not achieved, the logic is to reset the state machine, which re-initializes the state and the increased transmit power, and halts the timeout timer.

CLOSE State

In the CLOSE state, the system monitors the GAP connection state. If the smart phone 130 remains in connection with the module 110, the system concludes the smart phone 130 remains in proximity to the module so that the access points should be unlocked. The RSSI signal is then processed with a dedicated first order IIR filter. If the filtered RSSI signal reaches a very strong threshold level, possible only when the smart phone 130 is actually inside the vehicle, the logic directs dropping the BTLE transmit power to a low level (defined as the in-car transmit power level), and transition to the STABILIZING state. The purpose of dropping the transmit power at this point is to ensure that the connection is dropped rapidly once the user leaves the car.

If RSSI signal is not sufficiently strong before the timeout period expires, then logic moves to a loss of proximity or FAR AWAY STATE so that the doors command will be triggered and the doors will be locked, resetting the state machine.

If the smart phone 130 is no longer in range of the module 110 sufficient to establish a wireless connection, the logic determines if there is a timeout, which is set as described above. In the case of a timeout, a lock doors command is initiated with re-initialization the state machine. This addresses the case of wandering close to the car and then walking away without getting in.

STABILIZING State

In the STABILIZING state, the system continues to monitor the wireless communication link and if a connection is confirmed, the system evaluates any change in RSSI level. RSSI monitoring is done by running a first order IIR filter on the change in RSSI between this iteration of the state machine and the previous one. At the same time, the system also continue to filter the RSSI with its low pass filter. The system remains in the STABILIZING state until the RSSI stops changing, or the change in RSSI has to be below a threshold from iteration to iteration or a specified period of time.

Once the RSSI signal has stabilized for a period of time, indicating confidence that the RSSI is no longer significantly changing (i.e. the user is sitting and driving, with the phone put away in a pocket or purse or somewhere in the car), the system determines the low pass filtered RSSI signal, and defines a link loss RSSI value as the current value of the low pass filtered RSSI plus a hysteresis value (currently defined as 21 dBm). The link loss RSSI value is used to sever the connection in the VERY_CLOSE state.

If wireless connection is lost, the state machine logic is reset.

VERY_CLOSE State

In the VERY_CLOSE state, the system monitors the wireless connection and keeps running the low pass filter on the RSSI values, but the system changes filter tap values so that the RSSI can decay faster if the user moves away from the module. If the RSSI decays to weaker than link loss RSSI described in the previous sub-section, the link is severed and reset the state machine. If the link drops, logic resets the state machine.

Another highly desirable feature of passive keyless entry systems is the ability to allow users to program the functionality of the system. For example, when a mechanic is servicing a vehicle or the driver provides the keys to a valet, turning the system off so that a key is required to access the entry point, either through a manual or automated process is desirable. It may also be preferable to a use that the system only passively lock or passively unlock in some situations.

The system allows setting passive keyless entry control function through the graphical user interface of the smart phone app. The app is controlled through the touch screen and by pressing PKE control access button a small feature menu is accessed containing: Access PKE UI page; Shunt PKE page; Activate PKE page; Set Airport Mode page.

In the Access PKE page, the system allows user to view and select from various PKE programmable features. In the Activate PKE page, a smart phone is associated with the module and authorized for PKE communications with the module.

At that Access PKE UI page the user may switch PKE feature on/off. This is accomplished by sending a signal from the smart phone to the module to bypass the PKE logic until a signal is received from an authorized smart phone to reactivate the system. It is contemplated that multiple smart phones may be associated with a single modules and some smart phones may turn off the PKE features while other associated smart phones may use the PKE features.

The Access PKE UI page also allows user to selectively use just passive unlock, passive lock, or both. This is accomplished by modifying the logic to allow triggering the passive locking of the system only as the smart phone exits the perimeter of the trigger zone while disabling the passive unlock logic as the smart phone enters the perimeter. A similar change is made to the logic for turning off the passive locking. Alternatively, the user can shut down passive behavior either by sending a manual lock or unlock command, or by turning off Bluetooth on their handset. This allows them to stay in proximity to the vehicle and not have it lock/unlock as the range varies. For working in the garage, loading/unloading etc. For temporary bypass of PKE, PKE is automatically re-enabled if the smart phone handset is connected and goes out of range of the module, unless the user has turned PKE off on the app. To permanently disable the PKE system, a second switch for turning on/off passive features is included in the app. Turning on the Passive On/Off switch opens a new Bluetooth PKE UI page with the features described above, and a close button in the header for returning to the More/Settings page. Tapping any other lower row buttons will also close the Bluetooth PKE page. The app will convert BT icon in header bar into a button with BT icon that appears anytime there is an active BT connection with the module that is currently selected.

A highly desirable feature is location-based temporary disabling of the PKE system when the module is installed in a vehicle and the vehicle is located in a specified place. This is desirable in instances such as when a vehicle is parked in a home garage and the PKE system will trigger the lock mechanism as the vehicle owner moves in and out of the set trigger zone. This feature allows the user to select a point on a map and set it as a home location. The app queries the smart phone for GPS coordinates of the selected location. The user can then select, using an interface in the app, a perimeter around that point for automatic shunting of the PKE system. When the vehicle moves within the perimeter, the system is automatically disabled. When the vehicle exits the selected perimeter area, the PKE system is again enabled.

The user may select the desired behavior of the PKE locking system when in the specified shunting geo-zone. For example, the user may have the choice upon initial setup to have the system remain in the locked state or unlocked state until the user actively sends the next lock or unlock command.

In order to achieve the benefit of location-based passive shunting while not causing excessive battery drain on the user's smartphone, certain methods may be implemented in the associated smartphone application. Continuous polling of GPS location causes significant drain on a smartphone. To minimize this battery drain while still enabling the system to check the smartphone or vehicle location at the appropriate times, the system may be configured to only check for GPS location upon a major change in location of the phone (e.g. distance changed more than 1000 yards, or the phone switched to a new cell tower, etc). The system could also be programmed to check for location only immediately after each passive lock action. Upon such event, the system could then automatically switch to and remain in the desired lock/unlock state until the next “active” trigger (e.g. the user sends a manual lock/unlock command, or a major location change is noted).

The location-based passive shunting feature may be enabled by GPS information from a smartphone, as well as other methods of location awareness. These other methods could include the presence of a radio beacon signal such as a WIFI network associated with the user's home or office.

In another feature of the system when a specified amount of lock/unlock actions are made within a specified amount of time, the unit will send an async message to the phone to alert user/app that there is a toggling action. The message sent is TOG, normally unseen from the user. Default values are 1 minute and 4 toggling to be detected.

In another aspect of the invention, when the phone is determined to be disconnected, beyond the lock thresholds, it automatically lock the doors. This feature is not user programmable but is conditional to a compile option into the code. The reason to have a threshold is to avoid the situation where the phone sits on the driver seat, the battery goes dead in it and lock the doors. Having the software to see the last rssi value and compare it to the known lock threshold avoid this potential problem of locking the doors with the phone and potentially the keys too into the car.

It will be recognized by those skilled in the art that the passive keyless entry system of the invention is suitable for use with any product that has an entry or access point, such as a refrigerator or other appliance, a garage door system, a safe, etc. In one embodiment, the keyless entry system cooperates with an existing security system that acts to control a locking mechanism of the vehicle or building access point. For example, the keyless entry system might utilize the existing antenna and receiver of a home or vehicle security system, such that installation requires little more than plugging the module into a connector and reprogramming the security system to respond to signals from the user held transceiver of the passive keyless entry system. This can significantly reduce hardware and installation labor costs.

Passive keyless entry systems according to the teachings herein can be used in fixed structures, including for example homes, offices, or other buildings, and can also be adapted to movable structures, including for example, cars, boats, trucks, and so forth. Conversion kits for existing structures, especially cars and trucks, are especially contemplated.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. While the foregoing written description of the invention enables one of ordinary skill to make and use the invention, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. The present invention thus can be embodied in other specific forms without departing from its spirit or essential characteristics. The described embodiment is to be considered in all respects only as illustrative and not restrictive. The scope of the invention is, therefore, indicated by the appended claims rather than by the foregoing description.

What is claimed is:

1. A passive keyless entry system for controlling a locking mechanism associated with an access point, the system comprising:
a module located in proximity to the access point, the module in electrical communication with the locking mechanism and comprised of a first transceiver, a micro-controller, and memory;
a communication device comprised of a second transceiver, a third transceiver, a micro-processor, and a memory, the third transceiver in communication with a cellular phone network whereby executable code is downloaded from the cellular network to the communication device and stored in memory, and the second transceiver is paired for authorized communications with the first transceiver, the second transceiver transmitting a local wireless signal received by the first transceiver; and
whereby the module micro-controller executes the executable code to calculate the relative signal strength of the received signal at a selected distance of the communication device from the access point, the locking mechanism locking the access point when the signal strength is less than the calculated signal strength value and the locking mechanism unlocking the locking mechanism when the signal strength is greater than the calculated signal strength value.

2. The passive keyless entry system of claim 1, wherein the communication device is a smart phone.

3. The passive keyless entry system of claim 2, wherein the executable code is comprised of a graphical user interface providing for a configuration mode and an operating mode, the distance is selected by a user selectable distance icon displayed on the graphical user interface.

4. The passive keyless entry system of claim 2, wherein the executable code is further comprised of a configuration mode and an operating mode, wherein pairing is performed and the user selectable distance is selected while in the configuration mode and locking and unlocking is performed in the operating mode.

5. The passive keyless entry system of claim 1, wherein the second transmitter transmits an encoded signal representing a unique identifier sequence for identifying the communications device which is programmed into the module memory allowing the module to recognize the received signal as transmitted from an authorized communications device.

6. The passive keyless entry system of claim 1, wherein a plurality of modules are paired with the communication device.

7. The passive keyless entry system of claim 1, wherein the signal strength being less than the calculated signal strength value corresponds to the communication device being farther than the selected distance and the signal strength being greater than the calculated signal strength value corresponds to communication device being closer than the selected distance.

8. The passive keyless entry system of claim 1, wherein the module is in communication with the locking mechanism of an automotive vehicle.

9. The passive keyless entry system of claim 1, wherein the module is in communication with the locking mechanism of a building.

10. The passive keyless entry system of claim 1, wherein the signal strength is calculated by averaging the signal strength of a plurality of transmitted signals.

11. The passive keyless entry system of claim 1, wherein the graphical user interface provides an icon for selecting temporarily maintaining the locking mechanism in the unlock state.

12. A method for passively locking and unlocking an access point comprising the steps of:
1. associating module comprising a first transceiver, a micro-controller and a first memory, the module in electrical communication with a locking mechanism in proximity to the access point;
2. pairing for authorized communications with the module a communication device having a second transceiver, a third transceiver in communication with a cellular network, a micro-controller and a second memory, the communication device maintaining in the second memory executable code received from the third transceiver;
3. accessing the executable code on the communication device;
4. moving the communication device to a distance from the access point;
5. transmitting a signal from the second transceiver and receiving the signal at the first transceiver;
6. determining the signal strength of the transmitted signal at the distance from the access point;
7. providing a lock command to the lock mechanism when the signal strength is less than the determined signal strength and providing an unlock command to the lock mechanism when the signal strength is greater than the determined signal strength.

13. A method of claim 12 further comprised of step:
8. selectively disabling for a period of time step 7 by selection of a graphical user interface icon of the executable code on the communication device.

14. A method of claim 12 further comprised of step:
8. selectively enabling and disabling step 7 by selection of a graphical user interface icon of the executable code on the communication device.
